(19) United States
(12) Patent Application Publication
(10) Pub. No.: US 2012/0196309 A1
(43) Pub. Date: Aug. 2, 2012

(54) Methods and Kits for Detection of Antibiotic Resistance

(75) Inventors: David R. PEAPER, West Haven, CT (US); Thomas S. MURRAY, Middlebury, CT (US); Michael E. HODSDON, Hamden, CT (US)

(73) Assignee: Yale University

(21) Appl. No.: 13/350,071

(22) Filed: Jan. 13, 2012

Related U.S. Application Data
(60) Provisional application No. 61/437,443, filed on Jan. 28, 2011.

(51) Int. Cl. G01N 27/62

(52) U.S. Cl. 435/18; 435/34

(57) ABSTRACT

The present invention relates to a method of detecting antibiotic resistant bacteria in a sample. The method includes the steps of analyzing a sample derived from bacteria via mass spectrometry to produce a data set, and determining from the data set the presence or absence of a covalently modified antibiotic compound in the sample, wherein the presence of a covalently modified antibiotic compound in the sample is indicative that the bacteria are resistant to the antibiotic. The present invention also relates to a kit for determining the presence or absence of antibiotic resistant bacteria in a sample. The kit includes reagents for preparing and performing the assay, and instructions for the set-up, performance, monitoring, and interpretation of the assay.

### CROSS-REFERENCE TO RELATED APPLICATION

The present application is entitled to priority under 35 U.S.C. §119(e) to U.S. Provisional Application No. 61/437,443, filed Jan. 28, 2011, which application is hereby incorporated by reference in its entirety.

### BACKGROUND OF THE INVENTION

Multi-drug resistant Gram-negative bacteria continue to pose a global health problem. For example, Gram-negative bacteria, such as Klebsiella pneumonia, Pseudomonas aeruginosa and Escherichia coli, that are resistant to multiple antibiotics cause invasive infection in hospitals throughout the world. Outbreaks of infections by these organisms in health care settings, such as intensive care units, often result in increased morbidity and mortality, with death rates reaching as high as 69%. Compared with drug-susceptible bacteria, infection by drug resistant Gram-negative bacteria can extend the length of hospital stay by an extra 10-14 days, and incur increased costs of between about $16-30K per patient. Consequently, community outbreaks of infection with these organisms have been described following exposure to the healthcare system. The importance of drug-resistant, Gram-negative rods (GNR) in the care of hospitalized patients is highlighted by the Infectious Disease Society of America's mandate to develop new antibiotics to treat life-threatening infections caused by these organisms by 2020.

Beta-lactam antibiotics interfere with the synthesis of bacterial cell walls by inhibiting transpeptidases that catalyze the final cross-linking step in the synthesis of peptidoglycan. Examples of beta-lactam antibiotics include penicillins, cephalosporins, monobactams, and carbapenems. Beta lactam containing antibiotics are found in nature, and many organisms have evolved beta-lactamases that are capable of covalently modifying the beta-lactam ring, resulting in a loss of antibiotic activity. To counter the activity of beta lactamases, beta lactam antibiotics are often formulated with a beta lactamase inhibitor that does not have inherent antibiotic effects. Alternatively, modification of the chemical structure of naturally occurring penicillins has broadened the spectrum of these antibiotics and/or rendered them less susceptible to conventional beta lactamases. Unfortunately, the introduction of these antimicrobial agents has led to the evolution of new antibiotic resistant mechanisms; Gram-negative bacilli have developed extended spectrum beta lactamases (ESBLs) capable of hydrolyzing extended spectrum cephalosporins such as ceftazidime and cefotaxime.

One class of beta-lactam antibiotics, the carbapenems (e.g. imipenem, ertapenem, meropenem, and doripenem), are resistant to hydrolysis by most ESBLs, and their clinical use is typically reserved for severe infections with highly antibiotic resistant organisms. However, resistance to carbapenems can arise from several different mechanisms. For example, increased expression of efflux pumps and mutations in membrane porins prevent antibiotic entry into cells, leading to reduced intracellular drug levels, and, in these microbes, carbapenem resistance can occur in conjunction with high expression of ESBLs and AmpC, a family of enzymes with ESBL-like expressed by enterobacteriaceae. Further, some organisms also produce carbapenemases that can hydrolyze the carbapenems and other beta-lactams. In 1996, a unique carbapenemase was characterized from a K. pneumoniae isolate in North Carolina and called KPC for K. pneumoniae carbapenemase. While some carbapenamases, ESB1s and AmpC enzymes can be chromosomally encoded, many beta-lactamases and carbapenamases are encoded on plasmids that are easily shared among enterobacteriaceae. Thus, these genes can be transmitted among patients in close proximity and among those sharing health care providers.

Outbreaks of severe infections caused by KPC-producing organisms have been described, and these are associated with a high mortality rate. Infections with KPC-producing enterobacteriaceae are extremely difficult to treat, and clinicians must rely upon antibiotics having suboptimal antimicrobial properties that often have significant side effects. The clinical consequences of infection with KPC-producing organisms have led some to suggest that screening for colonization with KPC-positive organisms should be considered analogous to screening for other antibiotic resistant organisms such as methicillin-resistant Staphylococcus aureus (MRSA) and vancomycin-resistant enterococcus (VRE). However, no studies have documented that interventions based on KPC screening affect the treatment of patients or reduce the spread and/or prevalence of KPC-positive organisms. Additionally, there is no consensus within the microbiology laboratory community about how best to implement a screening program for KPC producing organisms.

One of the most common mechanisms of antibiotic resistance among the Gram-negative bacteria is the secretion of enzymes that covalently modify antibiotics, rendering them inactive. Bacteria that possess extended spectrum beta-lactamases (ESBL's) hydrolyze most cephalosporins, thereby reducing first line treatment options to the carbapenems. However, there are an increasing number of bacteria that now secrete enzymes that hydrolyze carbapenems, eliminating all first line therapeutic options for patients infected with these bacteria. Examples of such enzymes include the blaK carbapenemase from Klebsiella, some SHV-1, and metallo-Beta-lactamases. Since these enzymes are often encoded by genes residing on extra-chromosomal plasmids, DNA encoding them are also easily transferred to other bacteria. For example, DNA encoding the New Dehli metallo-beta lactamase (NDMBL) has been shown to be transferred from Pseudomonas aeruginosa to the enterobacteraciae, and expression of this enzyme has been found in countries around the globe. There is an urgent need to effectively contain and/or prevent infection by these bacteria, and therefore methods for the rapid detection of carbapenemase secreting bacteria are urgently desired. Delay in the institution of appropriate of antibiotic therapy is the primary risk factor for the increased mortality associated with resistant GNR infections. Rapid detection of carbapenemase producing bacteria could facilitate appropriate treatment earlier in the course of infection.

Unfortunately, current methods for detecting resistance are suboptimal. Molecular methods, such as those utilizing amplification via polymerase chain reaction (PCR), have been used for the rapid detection of ESBLs and carbapenemases. However, the limitations of this approach are several. First, multiplex PCR is required because multiple genes encode enzymes that hydrolyze carbapenems. Second, some enzymes may have multiple activities. For example, SHV enzymes may have carbapenemase activity or they may just hydrolyze cephalosporins. PCR assays that identify the gene do not distinguish between these activities. Third, the presence of a gene does not necessarily correlate with the level of resistance of an organism. Deletions in the promoter or differences in the gene copy number may also determine the minimum inhibitory concentration of carbapenem required to kill the organism. Fourth, novel genetic elements may emerge in bacteria that were not previously present (e.g., the introduction of NDMBL's into the enterobacteraciae), so primers that are used to detect these genes are not routinely included in assays for resistance.

A phenotypic assay for the detection of carbapenemase activity is appealing because it detects carbapenemase activity regardless of the enzyme responsible for the activity. There are several currently used assays including phenylboronic acid discs, the modified Hodge test, chromagar plates, automated microdilution broth assays, and E-strips or discs that detect the minimum inhibitory concentration of a carbapenem that is required to kill the bacteria. However, these phenotypic assays have two limitations that are difficult to overcome. First, most of these assays require incubation overnight so the time required for a result is typically 24 hours from the time the bacterium is first isolated in the clinical microbiology laboratory. Second, the sensitivity and specificity of the assays vary and in general are less than ideal. Thus, there is a significant gap in care because each of the prior art assays are not functional assays.

Therefore, there remains an urgent need in the art for compositions and methods for the rapid phenotypic and functional detection of multiple drug resistant bacteria. The present invention addresses this need.

### BRIEF SUMMARY OF THE INVENTION

The invention includes a method of detecting the presence of antibiotic resistant bacteria in a sample. The method comprises analyzing a sample via mass spectrometry to produce a data set. The method further comprises determining from the data set the presence or absence of a covalently modified antibiotic compound in the sample. According to the method, the presence of the covalently modified antibiotic compound in the sample is indicative that the sample comprises bacteria that are resistant to the antibiotic.

In one embodiment, the presence in the sample of the covalently modified antibiotic compound is further indicative of the presence in the sample of an active enzyme capable of covalently modifying the antibiotic. In another embodiment, the active enzyme comprises a hydrolase. In yet another embodiment, the hydrolase comprises a beta-lactamase. In yet another embodiment, the beta-lactamase comprises a carbapenemase. In yet another embodiment, the antibiotic compound comprises a carbapenem. In yet another embodiment, determining the presence or absence of a covalently modified antibiotic compound comprises comparing the data set to spectral analysis standards of the antibiotic compound in both a covalently modified and unmodified state. In yet another embodiment, analyzing via mass spectrometry comprises analyzing the sample using a LC-MS/MS system. In yet another embodiment, the LC-MS/MS system comprises UPLC-MS/MS. In yet another embodiment, the sample is from a patient. In yet another embodiment, the sample is derived from a source comprising blood, a blood culture, an epidemiologic surveillance swab, a body fluid, and combinations thereof In yet another embodiment, the sample is not from a patient. In yet another embodiment, determination of the presence or absence of antibiotic resistant bacteria is made in less than about 2 hours. In yet another embodiment, at least the determination of the presence or absence of antibiotic resistant bacteria is automated.

The invention further includes a method of detecting hydrolytic enzyme activity of drug resistant bacteria in a sample. The method comprises obtaining standards for the spectral analysis of at least one antibiotic compound in both a hydrolyzed and unhydrolyzed state. The method further comprises analyzing a sample via mass spectrometry to produce a data set. The method further comprises comparing the data set to the standards. The method further comprises determining the presence or absence of a hydrolyzed antibiotic compound in the sample. According to the method, the presence of the hydrolyzed antibiotic compound in the sample is indicative of the presence of an active hydrolytic enzyme that promotes bacterial resistance to the at least one antibiotic compound.

In one embodiment, the hydrolytic enzyme comprises a beta-lactamase. In another embodiment, the beta-lactamase comprises a carbapenemase. In yet another embodiment, the at least one antibiotic compound comprises a carbapenem. In yet another embodiment, analyzing via mass spectrometry comprises analyzing the sample using a LC-MS/MS system. In yet another embodiment, the LC-MS/MS system comprises UPLC-MS/MS.

The invention further comprises a kit for determining the presence or absence of drug resistant bacteria in a sample. The kit comprises reagents for preparing and performing a spectral analysis of a sample. The kit further comprises instructions for the set-up, performance, monitoring, and interpretation of the assay to determine the presence or absence of a covalently modified antibiotic compound in the sample. In one embodiment, the spectral analysis comprises using a LC-MS/MS system. In another embodiment, the presence of a covalently modified antibiotic compound in the sample is indicative of the presence of an active enzyme that promotes bacterial resistance to the antibiotic compound. In yet another embodiment, the LC-MS/MS system comprises UPLC-MS/MS.

### BRIEF DESCRIPTION OF THE DRAWINGS

The following detailed description of preferred embodiments of the invention will be better understood when read in conjunction with the appended drawings. For the purpose of illustrating the invention, there are shown in the drawings embodiments which are presently preferred. It should be understood, however, that the invention is not limited to the precise arrangements and instrumentalities of the embodiments shown in the drawings.

FIG. 1, comprising FIGS. 1A-1C, depict the detection of carbapenemase-mediated ertapenem hydrolysis. FIG. 1A depicts MS/MS production spectra for ertapenem (left panel) and its hydrolyzed form (right panel). The addition of H₂O to the hydrolyzed β-lactam ring leads to an increase of 18 Da in molecular weight. The precursor ion m/z (mass-to-charge) ratios are 476 and 494 Da/e⁻ for intact and hydrolyzed ertapenem, respectively, with corresponding product ions of 432 and 450 Da/e⁻. FIG. 1B depicts detection of hydrolyzed ertapenem after overnight incubation. TSB containing ertapenem was inoculated with 100 μL of 0.5 McFarland (McF) suspension of KPC-negative strain ATCC 1706 (upper panel) or KPC-producing strain ATCC 1705 (lower panel) and incubated for 18 hours at 37° C. before HPLC-MS/MS to detect ertapenem or hydrolyzed ertapenem. No spontaneous ertapenem hydrolysis was seen in broth alone (in the absence of carbapenemase expression), and no unhydrolyzed ertapenem was detected after overnight incubation in the presence of KPC-producing bacteria. FIG. 1C depicts complete carbapenemase-mediated hydrolysis of ertapenem within 2 hours. Ertapenem was added to 0.5 McF suspensions of KPC-negative K. pneumonia strain ATCC 1706 (Upper Panel) or KPC-producing K. pneumonia strain ATCC 1705 and allowed to incubate for two hours at 37° C. After processing, samples were subjected to HPLC-MS/MS to detect ertapenem (red tracing) or hydrolyzed ertapenem (blue tracing). No ertapenem hydrolysis was detected in the presence of KPC-negative bacteria, and no unhydrolyzed ertapenem was detected after a two-hour incubation with KPC-producing bacteria.

FIG. 2 is a schematic illustration of mass spectrometry as a diagnostic assay for carbapenem resistance, and how the sensitivity and specificity of mass spectrometry may be analyzed.

FIG. 3 is a schematic illustration of the specimen bacterial analysis. Carbapenemase detection can occur from isolated bacterial colonies, bacteria recovered from positive blood cultures, epidemiologic surveillance swabs, or body fluids (e.g., for example, urine, peritoneal fluid, pleural fluid, or cerebrospinal fluid). Bacteria and/or samples are incubated in broth in the presence of carbapenem antibiotic. Samples are processed, and subjected to mass spectrometric analysis. The appearance of specific ions associated with the activity of carbapenemase activity are monitored and used to determine resistance to antibiotic(s).

FIG. 4 is a series of graphs illustrating the rapid detection of carbapenemase activity. TSB containing 2.5 μg/mL was inoculated with 0.5 McF of ATCC 1706 (panel a) or ATCC 1705 (panels b and c) and incubated for either 0 minutes (panel c) or 30 minutes (panels a and b) before samples processing and UPLC-MS/MS analysis. Box (I) indicates hydrolyzed ertapenem, and Box (II) indicates intact ertapenem. Ertapenem hydrolysis was detected within 30 minutes of sample inoculation by carbapenemase-producing bacteria.

FIG. 5 is a series of graphs illustrating that ertapenem hydrolysis is specific for carbapenemase detection. TSB containing 2.5 μg/mL was inoculated with 0.5 McF of ESBL-expressing, carbapenemase-negative clinical isolates (panels a and b), ESBL-negative, carbapenemase-negative ATCC 1706 (panel c), or KPC-positive ATCC 1705 (panel d). Samples were incubated for 1 hour at 37° C. before sample processing and UPLC-MS/MS analysis. Box (I) indicates hydrolyzed ertapenem, and Box (II) indicates intact ertapenem. Ertapenem hydrolysis was only detected in the presence of carbapenemase expression, and no “off-target” hydrolysis was seen by ESBL-expressing bacteria.

FIG. 6, comprising FIGS. 6A-6C, is a series of graphs illustrating the detection of carbapenemase activity directly from growth-positive blood culture bottles. Anaerobic Lytic BacTec blood culture bottles were inoculated with 1 mL of an 0.5 McF suspension of KPC-positive ATCC 1705 or carbapenemase-negative ATCC 1706 bacteria. Inoculated bottles were then placed on a BacTec Fx blood culture monitoring system, and when bacterial growth was detected (approximately 5 hours after inoculation), 1 mL of supernatant was removed from the bottle and spun at 13,000 rpm in a microcentrifuge tube. The pellet was resuspended in 1 mL of TSB with 2.5 μg/mL of ertapenem and incubated for 2 hours at 37° C. Following incubation, ceftazidime was added at 1 μg/mL as an extraction control, and samples were processed as described and analyzed by UPLC-MS/MS. Box A indicates ceftazidime, Box B indicates hydrolyzed ertapenem, and Box C indicates indicate intact ertapenem. Ertapenem hydrolysis was only detected from cellular material from blood cultures harboring carbapenemase positive bacteria.

FIG. 7, comprising FIGS. 7A-7C, illustrates specific loss of ceftazidime in the presence of ESBL-expressing bacteria. ESBL positive (FIGS. 7A & 7C) or ESBL negative (FIG. 7B) K. pneumoniae were incubated in the presence (FIGS. 7B & 7C) or absence (FIG. 7A) of 2 μg/mL of ceftazidime overnight in TSB at 37° C. Samples were processed as above and subjected to UPLC-MS/MS analysis. MRM for the detection of ceftazidime was 547→468. There was a specific loss of ceftazidime (reflected by the decreased peak area) in the presence of ESBL activity.

FIG. 8 is a graph illustrating linearity and dynamic range of UPLC-MS/MS method for the detection ertapenem. Ertapenem was diluted to the indicated concentrations in water or TSB. Ertapenem containing solutions were subjected to acetonitrile precipitation, centrifugation, and supernatants were analyzed by UPLC-MS/MS. The assay demonstrates linearity from 0.01 μg/mL to 100 μg/mL in both water and TSB. The physiologic concentrations of ertapenem required for therapeutic efficacy (approximately 2 μg/mL) fall within this range.

FIG. 9 illustrates the performance of UPLC-MS/MS assay for the detection of carbapenemase activity compared to the Modified Hodge Test. 12 K. pneumoniae isolates (upper panel) and 20 other Enterobacteriaceae species (lower panel) were incubated in the presence of 2.5 μg/mL of ertapenen for 1 hour, processed as described, and subjected to UPLC-MS/MS analysis. Ratios of the integrated area of hydrolyzed ertapenem peaks to the area of unhydrolyzed peaks were calculated, and any ratio >11 was considered “MS Assay Positive.” In parallel, the Modified Hodge Test was performed and interpreted as described (CLSI M100-521). Ertapenem resistance was determined by disk diffusion testing using CLSI M100-S21 interpretive criteria. KPC and NDM1 expression were determined by PCR. ESBL expression was determined phenotypically by disk diffusion using ceftazidime and cefotaxime disks with and without clavulinic acid as describe (CLSI M100-S21).

### DETAILED DESCRIPTION OF THE INVENTION

The present invention provides methods and kits for the detection of antibiotic-resistant bacteria. The methods include a novel phenotypic, rapid high-throughput assay using mass spectrometry to detect covalently modified and unmodified antibiotics, such as, and not limited to, carbapenems, and this data may be correlated to the presence or absence of enzymatic activity in a sample. The present invention also includes methods for detecting a change in an antibiotic molecule that is the result of bacterial enzymatic activity associated with antibiotic resistance of the bacteria. In one embodiment, the change in the antibiotic molecule comprises hydrolysis of the antibiotic molecule, which causes decrease in the signal for the antibiotic molecule. The present invention further includes methods of detecting any change in an antibiotic molecule that leads to a decrease or loss of antibiotic function.

The present invention also includes an assay kit containing reagents for the detection of enzymes that covalently modify antibiotics, e.g., carbapenemase activity, in bacteria isolated from clinical specimens and other samples, and instructions for the set-up, performance, monitoring, and interpretation of the assays of the present invention. The assay kits for detection of these enzymes can be used with any type of commercially available LC-MS/MS system. The assay kits include reagents for the detection of enzymatic activity in or from bacteria present in newly positive blood cultures, in patient specimens, in asymptomatic patients for screening and/or surveillance purposes, and in non-clinical samples, and further include instructions for use of the kit on at least one make/model of a commercially available LC-MS/MS system.

### Definitions

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

As used herein, the term “UPLC” refers to ultra-performance liquid chromatography.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20% or ±10%, more preferably ±5%, even more preferably ±1%, and still more preferably ±0.1% from the specified value, as such variations are appropriate to perform the disclosed methods.

“Bacterium” or “bacteria,” as these terms are used herein, refer to a single-celled prokaryotic organism or organisms, respectively. The use of the singular “bacterium” or plural “bacteria” should not necessarily be construed to imply any clonality in the population of organisms described, but should also not exclude clonality of the organisms under certain circumstances.

“Beta-lactam antibiotic,” as that term is used herein, refers to a class of antibiotics that are typically used to treat a broad spectrum of Gram-positive and Gram-negative bacteria.

“Hydrolase,” as the term is used herein, refers to an enzyme that catalyzes the hydrolysis of a chemical bond. Hydrolases may hydrolyze, for examples, ester bonds (commonly known as esterases, for example: nucleases, phosphodiesterases, lipases, and phosphatases), sugarlinkages (for example, DNA glycosylases and glycoside hydrolases), ether bonds, peptide bonds (for example, proteases and peptidases, such as but not limited to beta-lactamases), carbon-nitrogen bonds (other than peptide bonds), acid anhydrides (for example, acid anhydride hydrolases, including helicases and GTPases), carbon-carbon bonds, halide bonds, phosphorus-nitrogen bonds, sulfur-nitrogen bonds, carbon-phosphorus bonds, sulfur-sulfur bonds, and carbon-sulfur bonds.

“Beta-lactamase,” as that term is used herein, refers to a hydrolase enzyme that is produced by some bacteria and is responsible for resistance of the bacteria to beta-lactam antibiotics, such as, but not limited to, penicillins, cephalosporins, and carbapenems (ertapenem). These antibiotics have a common element in their molecular structure: a four-atom ring known as a beta-lactam. The lactamase enzyme breaks that ring open, deactivating the molecule's antibacterial properties. Beta-lactamases produced by Gram-negative organisms are usually secreted.

The molecular classification of β-lactamases is based on the nucleotide and amino acid sequences in these enzymes. To date, four classes are recognized (A-D), correlating with the functional classification. Classes A, C, and D act by a serine-based mechanism, whereas class B or metallo-β-lactamases need zinc for their action. Thus, beta-lactamases are classed functionally as follows:

Group 1 β-lactamases are cephalosporinases not inhibited by clavulanic acid, belonging to the molecular class C;

Group 2 β-lactamases are penicillinases, cephalosporinases, or both, inhibited by clavulanic acid, corresponding to the molecular classes A and D reflecting the original TEM and SHV genes. However, because of the increasing number of TEM- and SHY-derived {beta}-lactamases, antibiotics in this class have been divided into two subclasses, 2a and 2b:
Group 2 β-lactamases contain just penicillinases, molecular class A;
Group 2 β-lactamases are broad-spectrum beta-lactamases, molecular class A, meaning that they are capable of inactivating penicillins and cephalosporins at the same rate.

New subgroups have been segregated from subgroup 2b;
Group 2be—extended spectrum of activity, extended spectrum molecular class A, represents the ESBLs, which are capable of inactivating third-generation cephalosporins (ceftazidime, cefotaxime, and cefpodoxime) as well as monobactams (aztreonam);
Group 2br—inhibitor resistant, molecular class A (diminished inhibition by clavulanic acid), these enzymes, with the letter “r” denoting reduced binding to clavulanic acid and sulbactam, are also called inhibitor-resistant TEM-derivative enzymes; nevertheless, they are commonly still susceptible to tazobactam, except where an amino acid replacement exists at position met69;
   Group 2c β-lactamases—carbenicillinase, molecular class A, subgroup 2c was segregated from group 2 because these enzymes inactivate carbenicillin more than benzylpenicillin, with some effect on cloxacillin;
   Group 2d β-lactamases—oxacillinase, molecular class D, subgroup 2d enzymes inactivate the oxazolylpenicillins such as oxacillin, cloxacillin, dicloxacillin more than benzylpenicillin, and have some activity against carbenicillin; these enzymes are poorly inhibited by clavulanic acid, and some of them are ESBLs and carbapenemases;
   Group 2e β-lactamases—cephalosporinase, molecular class A, subgroup 2e enzymes are cephalosporinases that can also hydrolyse monobactams, and they are inhibited by clavulanic acid;
   Group 2f β-lactamases—carbapenamase, molecular class A, subgroup 2f enzymes are serine-based carbapenemases, in contrast to the zinc-based carbapenemases included in group 3;
   Group 3 β-lactamases—metalloenzyme, molecular class B (not inhibited by clavulanic acid), these are the zinc based or metallo {beta}-lactamases, corresponding to the molecular class B, which are the only enzymes using zinc for activity. Metallo B-lactamases are able to hydrolyse penicillins, cephalosporins, and carbapenems. Thus, carbapenems are inhibited by both group 2f (serine-based mechanism) and group 3 (zinc-based mechanism);
   Group 4 β-lactamases—penicillinase, no molecular class (not inhibited by clavulanic acid), these enzymes are penicillinases that are not inhibited by clavulanic acid;

AmpC enzymes are molecular class C, but they don't have a functional classification. The assay of the invention can detect ampC activity.

“Covalent modification” of an antibiotic, as used herein, means, without limitation, oxidation, reduction, hydrolysis, conjugation, including specifically, hydroxylation, dehydrogenation, sulfation, glucuronidation, acetylation, acylation, methylation, aminoacylation, phosphorylation, glutathione conjugation, glycine conjugation, epoxidation, isomerization, decarboxylation, and the like.

A “coding region” of a gene consists of the nucleotide residues of the coding strand of the gene and the nucleotides of the non-coding strand of the gene which are homologous with or complementary to, respectively, the coding region of an mRNA molecule which is produced by transcription of the gene.

A “coding region” of an mRNA molecule also consists of the nucleotide residues of the mRNA molecule which are matched with an anti-codon region of a transfer RNA molecule during translation of the mRNA molecule or which encode a stop codon. The coding region may thus include nucleotide residues corresponding to amino acid residues which are not present in the mature protein encoded by the mRNA molecule (e.g., amino acid residues in a protein export signal sequence).

“Encoding” refers to the inherent property of specific sequences of nucleotides in a polynucleotide, such as a gene, a cDNA, or an mRNA, to serve as templates for synthesis of other polymers and macromolecules in biological processes having either a defined sequence of nucleotides (i.e., rRNA, tRNA and mRNA) or a defined sequence of amino acids and the biological properties resulting therefrom. Thus, a gene encodes a protein if transcription and translation of mRNA corresponding to that gene produces the protein in a cell or other biological system. Both the coding strand, the nucleotide sequence of which is identical to the mRNA sequence and is usually provided in sequence listings, and the non-coding strand, used as the template for transcription of a gene or cDNA, can be referred to as encoding the protein or other product of that gene or cDNA.

Unless otherwise specified, a “nucleotide sequence encoding an amino acid sequence” includes all nucleotide sequences that are degenerate versions of each other and that encode the same amino acid sequence. Nucleotide sequences that encode proteins and RNA may include introns.

A “disease” is a state of health of an animal, preferably a mammal and more preferably, a human, wherein the animal cannot maintain homeostasis, and wherein if the disease is not ameliorated then the animal's health continues to deteriorate.

In contrast, a “disorder” in an animal is a state of health in which the animal is able to maintain homeostasis, but in which the animal's state of health is less favorable than it would be in the absence of the disorder. Left untreated, a disorder does not necessarily cause a further decrease in the animal's state of health.

A disease or disorder is “alleviated” if the severity of a symptom of the disease or disorder, the frequency with which such a symptom is experienced by a patient, or both, is reduced.

As used herein, an “instructional material” includes a publication, a recording, a diagram, or any other medium of expression which can be used to communicate how to use the kit of the invention. Optionally, or alternately, the instructional material can describe one or more methods of for use of the kit of the invention. The instructional material of the kit of the invention can, for example, be affixed to a container which contains the kit, or be shipped together with a container which contains the kit. Alternatively, the instructional material can be shipped separately from the container with the intention that the instructional material and the kit be used cooperatively by the recipient.

“Isolated” means altered or removed from the natural state. For example, a nucleic acid or a peptide naturally present in a living animal is not “isolated,” but the same nucleic acid or peptide partially or completely separated from the coexisting materials of its natural state is “isolated.” An isolated nucleic acid or protein can exist in substantially purified form, or can exist in a non-native environment such as, for example, a host cell.

“Naturally occurring” as used herein describes a composition that can be found in nature as distinct from being artificially produced. For example, a nucleotide sequence present in an organism, which can be isolated from a source in nature and which has not been intentionally modified by a person in the laboratory, is naturally occurring.

The term “mass spectrometry (MS),” as used herein, means an analytical technique that measures the mass-to-charge ratio of charged particles. It is used for determining masses of particles, for determining the elemental composition of a sample or molecule, and for elucidating the chemical structures of molecules, such as peptides and other chemical compounds. The MS principle consists of ionizing chemical compounds to generate charged molecules or molecule fragments and measurement of their mass-to-charge ratios. In a typical MS procedure, a sample is loaded onto the MS instrument, and undergoes vaporization; the components of the sample are ionized by one of a variety of methods (e.g., by impacting them with an electron beam), which results in the formation of charged particles (ions); the ions are separated according to their mass-to-charge ratio in an analyzer by electromagnetic fields; the ions are detected, usually by a quantitative method; and the ion signal is processed into mass spectra.

A “mass spectrophotometer,” as used herein, comprises three modules: an ion source, which can convert gas phase sample molecules into ions (or, in the case of electrospray ionization, move ions that exist in solution into the gas phase); a mass analyzer, which sorts the ions by their masses by applying electromagnetic fields; and a detector, which measures the value of an indicator quantity and thus provides data for calculating the abundances of each ion present.

The terms “patient,” “subject,” “individual,” and the like, are used interchangeably herein, and refer to any animal, or cells thereof whether in vitro or in situ, amenable to the methods described herein. Preferably, the patient, subject or individual is a mammal, and more preferable, a human.

The term “sample” as used herein, includes a clinical sample obtained from a patient, such as, but not limited to, blood, lymph, urine, spinal or synovial fluid, or a tissue sample obtained from any organ or region of the body. A sample may also include a non-clinical solid, such as a surface of some type, or a non-clinical liquid, such as a solution or other liquid that might be used in a clinical setting. A sample can also be a culture, mixed or pure, of bacteria.

The term “treatment” as used within the context of the present invention is meant to include therapeutic treatment as well as prophylactic, or suppressive measures for the disease or disorder. Thus, for example, the term “treatment” includes the administration of an agent prior to or following the onset of a disease or disorder thereby preventing or removing all signs of the disease or disorder. As another example, administration of the agent after clinical manifestation of the disease to combat the symptoms of the disease comprises “treatment” of the disease.

A “therapeutic” treatment is a treatment administered to a subject who exhibits signs of pathology, for the purpose of diminishing or eliminating those signs.

As used herein, “treating a disease or disorder” means reducing the frequency with which a symptom of the disease or disorder is experienced by a patient. Disease and disorder are used interchangeably herein.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

### Methods of the Present Invention

The present invention includes methods and procedures for the detection of drug-resistant, i.e., antibiotic-resistant bacteria. The methods of the present invention rely on the performance of a novel phenotypic, rapid high-throughput assay using mass spectrometry to detect bacterial hydrolysis of carbapenems. However, the invention should not be construed as being limited solely to the detection of bacterial hydrolysis of carbapenems, but rather should be construed to include the detection of any change in an antibiotic molecule that is the result of bacterial enzymatic activity associated with antibiotic resistance of the bacteria. Preferably, the change detected in the antibiotic molecule is covalent modification, and more preferably, the change is hydrolysis of the antibiotic. The methods of the present invention further include the detection of any change in an antibiotic molecule in a sample, detectable by mass spectrometry, which leads to a decrease or loss of antibiotic function of the molecule. For example, the technology and diagnostic assays of the present invention are also applicable to other secreted enzymes that cause antimicrobial resistance, such as ESBL enzymes. In other embodiments, the present invention can be used for the detection of enzyme activity directly from blood cultures containing Gram-negative organisms. In another embodiment, the present invention can be used for detection of carbapenemase activity in primary samples with mixed populations of bacteria. In yet another embodiment, the sample is a non-clinical sample, such as, but not limited to, a solid such as a hard surface, for example, a table surface, a surface in a bathroom, a door knob, or a liquid, or any other sample that is not in some way obtained from a patient. The sample may also be a simple bacterial culture from any source.

### Analytical Methodologies

Different beta-lactamases degrade carbapenems through different mechanisms (such as by serine beta-lactamases, metallo beta-lactamases and carbapenemases, for example), but the end product of all beta-lactamase/carbapenemase activity is hydrolysis of the beta-lactam ring. The addition of H₂O predictably adds 18 Da to the molecular weight of the unhydrolyzed drug. Thus, as has been discovered herein, mass spectrometry (MS) is an ideal and highly sensitive methodology for detection of small, predictable changes in the molecular weight of analytes. Methods for therapeutic drug monitoring (TDM) using high performance liquid chromatography (HPLC) electrospray ionization (ESI)-MS are well established in clinical chemistry laboratories.

Aspects included in the methods and procedures of the present invention include use and control of specific growth media, antibiotic concentrations, internal standards, incubation procedures, and mass spectrometric methods, such as HPLC/UPLC-ESI-MS/MS, MALDI-Q/TOF, and others, for example. Any or all of these aspects can be optimized or otherwise altered to create a uniform method, or to create specialized methods for detecting the presence or absence of a specific enzymatic activity and/or the presence or absence of enzymatic activity for a specific bacterial species.

In the examples disclosed herein, liquid chromatography-coupled, electrospray ionization, triple quadrupole mass spectrometry (LC-(ESI)-MS/MS) is used. However, the invention should also be construed to include a different ionization device with an otherwise identical setup (such as “atmospheric pressure chemical ionization” or APCI): “LC-(APCI)-MS/MS”. In addition, gas chromatography may be added so that GC-(ESI)-MS/MS)or GC-(APCI)-MS/MS is used. Alternatively, a “Q-TOF” (quadrupole-“time-of-flight” MS) may be used, abbreviated as LC-(ESI)-Q-TOF. Other possibilities include MALDI-TOF, MALDI-Q-TOF, where MALDI is an ionization method often used without a chromatographic step. Thus, the invention should be construed to include all uses of mass spectrometry and the term LC-MS/MS is therefore used herein as the preferred designation of mass spectroscopy.

In one aspect, use of UPLC (ultra-performance liquid chromatography)-MS/MS allows for increased signal to noise which leads to increased analytic sensitivity (lower limit of detection). This allows for lower concentrations of drug used: in physiologic range of activity including closer to enzyme Kₘ values and bacterial MICs. This also allows for shorter incubation times, with detection of hydrolyzed drug within 30 minutes, and hydrolysis being complete within 1 hr. This also allows for better interpretive criteria. Because of the above mentioned points, UPLC-MS/MS analysis provides a positive or negative result that does not require more complex interpretive criteria, such as ratios of peak areas.

In one aspect, use of UPLC-MS/MS allows for more complex source materials. The assay considered herein uses complete microbial growth broth rather than saline. Saline or minimally enriched broth is likely required for the MALDI-TOF assay because there is no chromatographic separation in the MALDI-TOF assay. UPLC-MS/MS allows for separation of salts away from the target of interest, providing greater signal to noise. Further, UPLC-MS/MS allows for the use of longer incubation conditions in order to detect small numbers of resistant bacteria in primary samples (e.g. surveillance swabs), since bacteria are able to utilize complete growth medium. It should be noted that blood cultures, urine, body fluids contain many different proteins, peptides, and small molecules that could negatively affect the performance of the MALDI-TOF, and UPLC separates all of these from the targets of interest in the assay.

In one aspect, UPLC-tandem mass spec (triple quad) allows for more confidence in results because of precursor/product ion scans coupled with chromatographic retention times. In contrast, MALDI-TOF allows only observing one ion in one dimension. Complex biological material including bacterial components may have identical m/z that may interfere with detection of intact and/or hydrolyzed drugs. UPLC-MS/MS has multiple confirmatory steps that increases the reliability of the results: retention time, precursor ion m/z, and product ion m/z may be used under precisely controlled UPLC and MS conditions to make an identification. In fact, preliminary experiments have identified several distinct compounds of identical precursor ion m/z in growth broths and blood culture bottles. Thus, in one embodiment, due to the differences in the underlying technologies between MALDI-TOF v. UPLC-MS/MS, the assay described herein in more suited for use on biologically complex samples such as a growth broth, blood culture material, surveillance swabs, body fluids, and tissue.

As contemplated herein, the methods and procedures of the present invention may include any or all of the following non-limiting steps. First, a microbiology technologist or other user can prepare a suspension of bacteria in a growth media. The turbidity of the suspension can be compared to a provided reference solution. A specified volume of this suspension can be added to the tube containing lyophilized drug and internal standards. This solution can then be vortexed to dissolve the lyophilized compounds, and incubated at a specified temperature for a specific period of time (such as in heat block, standing incubator, or water bath, for example). Following incubation, bacteria can be removed by centrifugation in a standard table-top microcentrifuge, and a specified volume of bacterial supernatant can be added to a specified volume of protein precipitation buffer, vortexed, and centrifuged in a standard table-top centrifuge. A specified volume of this supernatant can then be transferred to a provided tube for placement in an HPLC-MS/MS instrument. Using provided instructions, specific parameters can be set on the instrument, including type of column used (matrix, length, bead size), mobile and stationary phases/solutions, injection volume, flow rate, wash steps, run duration and sample diversion (i.e. solvent delay), for example. For the mass spectrometer, methods can be provided or specified that indicate all mass spectrometer parameters (all voltages, temperatures, and pressures) and multiple-reaction-monitoring conditions (parent and daughter masses of non-hydrolyzed drug, hydrolyzed drug, and internal standards), for example. Finally, interpretive guidelines can be provided based on the HPLC retention time and relative signal intensities for the controls and internal standards. These can specify the conditions necessary for a run to be considered valid, including expected values for control reactions and expected values for internal standards. For valid assay runs, interpretive criteria can be provided for test results based on the relative intensity of signals for unhydrolyzed and hydrolyzed drug from clinical specimens. These interpretative criteria can alternatively be implemented in the form of software or a macro that provides preliminary interpretation of assay validity and results pending technologist input. It should be appreciated that, while there is no requirement that the aforementioned steps be performed in any particular order, some steps should necessarily be sequential to others as would be understood by those skilled in the art.

### Assay Kits of the Present Invention

The present invention further includes an assay kit containing reagents for the detection of enzyme production by bacteria, where the enzyme is capable of covalently modifying an antibiotic, preferably capable of hydrolyzing an antibiotic.

In one embodiment, the kit includes reagents for the detection of enzyme production, preferably carbapenemase production, by bacteria isolated from a clinical or non-clinical sample, and instructions for the set-up, performance, monitoring, and interpretation of the assays of the present invention. The detection of enzyme production can be assessed by any type of commercially available LC-MS/MS system as disclosed elsewhere herein. For example, the assays of the present invention may be performed on a Waters TQD instrument, which is a widely used HPLC-ESI-MS/MS platform.

In one embodiment, the kit includes a container (e.g., a tube) containing lyophilized antibiotic, preferably carbapenem, and lyophilized internal standard(s), suitable growth media, a turbidity standard in growth media, transfer pipets, protein precipitation buffer, tubes, control bacteria and/or enzymes, and instructions for the use thereof in conjunction with a LC -MS/MS system. Additionally, the present invention may include novel software developed to assist and automate assay performance and interpretation.

In another embodiment, the kit may contain additional and/or appropriate reagents for the detection of enzyme, preferably carbapenemase production by bacteria present in newly positive blood cultures, and instructions for use of the kit on at least one make/model of a commercially available LC-MS/MS system. Because the composition and bacterial content of blood culture bottles can vary among patients and manufacturers of blood culture systems, inoculum, pre-inoculation manipulation, growth media, and growth conditions (e.g. temperature and duration) can be modified to meet these parameters. Once incubated, the processing and handling of the specimens can be performed as described in other embodiments, and may be further optimized as needed (e.g. protein precipitation buffer). Additionally, because the composition of the growth media may differ from that described in other embodiments, modification of the HPLC and/or MS/MS methods can be made, as needed.

In another embodiment, the kit may contain additional and/or appropriate reagents for the detection of enzyme, preferably, carbapenemase production by bacteria present in a patient specimen, and instructions for use of the kit using at least one make/model of commercially available LC-MS/MS system. Because the composition and bacterial content of primary patient specimens, such as sputum, wounds, other body fluids, including but not limited to blood, lymph, urine, synovial fluid and cerebrospinal fluid, can vary among patients, the inoculum, pre-inoculation manipulation, growth media, and growth conditions (e.g. temperature and duration) can all be modified, as needed and as determined by the skilled artisan performing the method according to instructions provided with the kit. Once incubated, the processing and handling of the specimens can be performed as described in other embodiments, and may be further optimized as needed (e.g. protein precipitation buffer). Additionally, because the composition of the growth media may differ from that described in other embodiments, modification of the HPLC and/or MS/MS methods can also be made, as needed and as determined by the skilled artisan.

In another embodiment, the kit may contain additional reagents for the detection of enzyme, preferably carbapenemase production by colonizing bacteria in samples obtained from asymptomatic patients for screening and/or surveillance purposes, and instructions for the use of the kit using at least one make/model of a commercially available LC-MS/MS system. In one example, the sample used may be a rectal swab obtained from the asymptomatic patient. Bacterial growth media is inoculated with the swab and the test is performed following the instructions provided herein. The inoculum, pre-inoculation manipulation, growth media, and growth conditions (e.g. temperature and duration) may be modified, as determined by the skilled artisan. Once incubated, the processing and handling of the specimens is performed as described in this and in other embodiments, and may be further optimized as desired. Additionally, because the composition of the growth media may differ from that described in other embodiments, modification of the HPLC and/or MS/MS methods may also be made, as desired.

Detection of enzymatic activity by mass spectrometry as a measure of antibiotic resistance, using the methods and assays of the present invention, has several advantages over currently available genetic and phenotypic techniques for detection of antibiotic resistance in bacteria. For example, the method of the present invention can detect hydrolysis by any enzyme having carbapenemase activity, thereby bypassing the problem of genetic diversity associated with PCR-based assays. Further, by assessing enzymatic activity, the methods establish that the enzyme is actually present in the sample. By contrast, genetic assays only detect the presence of the gene and do not confirm that it is in fact expressed by the bacteria. Analyses that are limited to the presence or absence of a gene incur a higher number false positive results in the test performed. Further, methods designed to detect actual enzyme activity are more sensitive than those that merely assess level of a particular protein levels because knowledge of the level of a protein in a sample does not in itself establish function of the protein.

The methods and assays of the present invention also facilitate detection of covalent modification of an antibiotic, preferably carbapenem hydrolysis, in about two hours or less using a standard bacterial inoculum. In other embodiments, detection is possible within about one and a half hours, or even one hour or even thirty minutes or less. Thus, detection of enzymatic activity in a sample can be performed using the methods of the present invention much more quickly than by using existing phenotypic testing methods.

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, it should be understood, that modifications in reaction conditions, including but not limited to reaction times, reaction size/volume, and experimental reagents, such as solvents, catalysts, pressures, atmospheric conditions, e.g., nitrogen atmosphere, and reducing/oxidizing agents, with art-recognized alternatives and using no more than routine experimentation, are within the scope of the present application.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

The following examples further illustrate aspects of the present invention. However, they are in no way a limitation of the teachings or disclosure of the present invention as set forth herein.

### EXAMPLES

The invention is now described with reference to the following Examples. These Examples are provided for the purpose of illustration only, and the invention is not limited to these Examples, but rather encompasses all variations that are evident as a result of the teachings provided herein.

As explained herein, the present invention includes a novel, high-throughput phenotypic assay for the detection of carbapenemase-secreting Gram-negative bacteria using mass spectrometry.

### Example 1

### Mass Spectrometry Detects the Hydrolysis of Ertapenem in Clinical Samples

Proof of principle experiments were performed using a well characterized KPC-positive, K. pneumoniae strain to demonstrate that the assay of the present invention is rapid and reproducible.

In one embodiment, the following protocol was used. MS/MS parameters were adjusted using ertapenem reconstituted in H₂O. The KPC-producing and KPC-negative K. pneumoniae strains ATCC 1705 and ATCC 1706, respectively, were used as described herein. For detection of ertapenem in biological samples, bacteria were inoculated into tryptic soy broth (TSB) in the presence of ertapenem (2.5 mcg/mL) and incubated for the indicated period of time. Bacteria were removed by centrifugation at 13,000 rpm for 5 minutes, 500 μL of supernatant was decanted to new tubes, and an equal volume of 100% acetonitrile was added to precipitate proteins. After vortexing, samples were centrifuged at 13,000 rpm for 5 minutes, and supernatants were decanted to a new tube for HPLC-MS/MS analysis. Samples (25 μL) were injected onto an HSS T3 column (2.1 mm×100 mm; 1.8 μm) (Waters, Beverly Mass.). Flow rate was 0 5 mL per minute, and a gradient of 20% to 25% solvent B (acetonitrile/formic acid 99.9/0.01%) with solvent A (water/formic acid 99.9/0.01%) was run between 0 min and 2.0 min using a Binary Solvent Manager for UPLC (Waters, Beverly Mass.). Total run time was 2.5 minutes and a solvent delay was used between 0 and 0.6 minutes and 2.0 and 2.5 minutes. MS/MS analysis was performed using a TQ Detector (Waters, Beverly Mass.). Nitrogen was used as the desolvation gas (650 L/hr) and cone gas (100 L/hr). The pressure of the argon collision cell was 5.5×10⁻³ mbar. The source temperature was maintained at 120° C., the desolvation temperature was 350° C., the cone voltage was 22 V, and the capillary voltage was 2.75 kV. Analytes were detected in positive ion mode by multiple reaction monitoring (MRM).

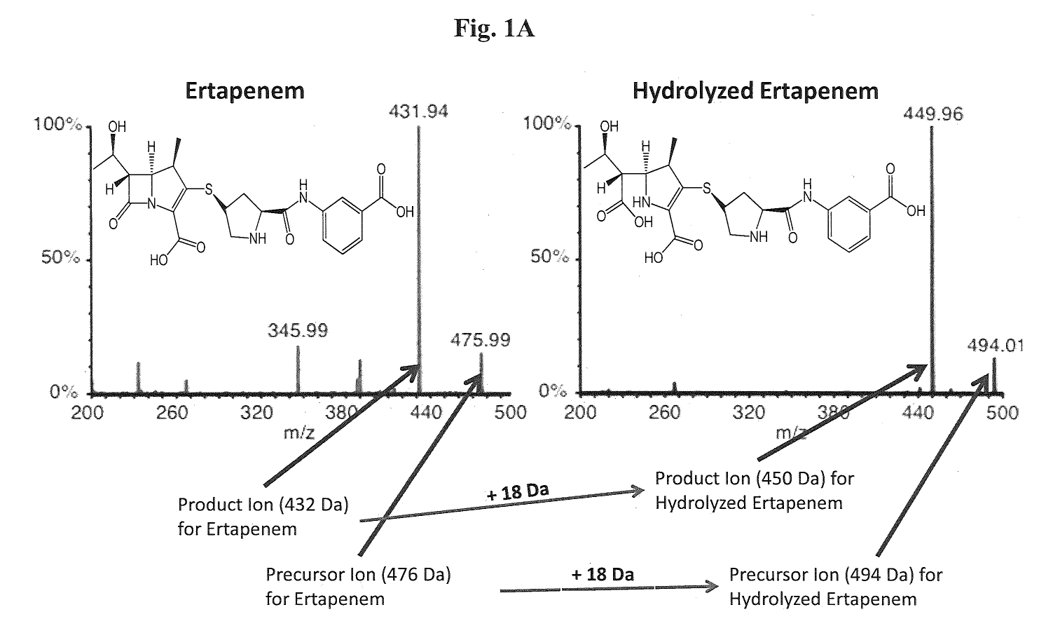

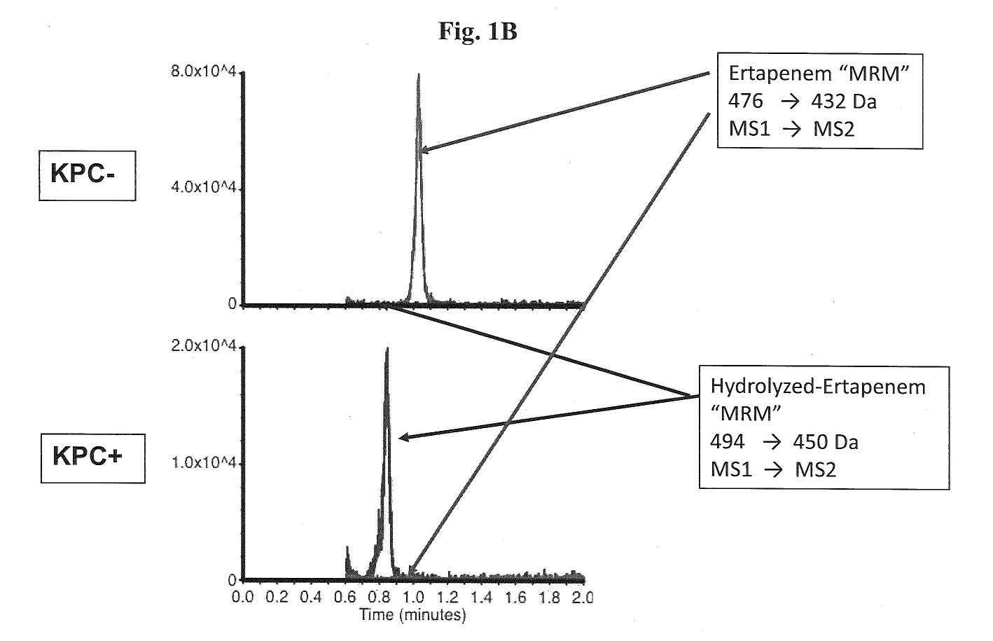

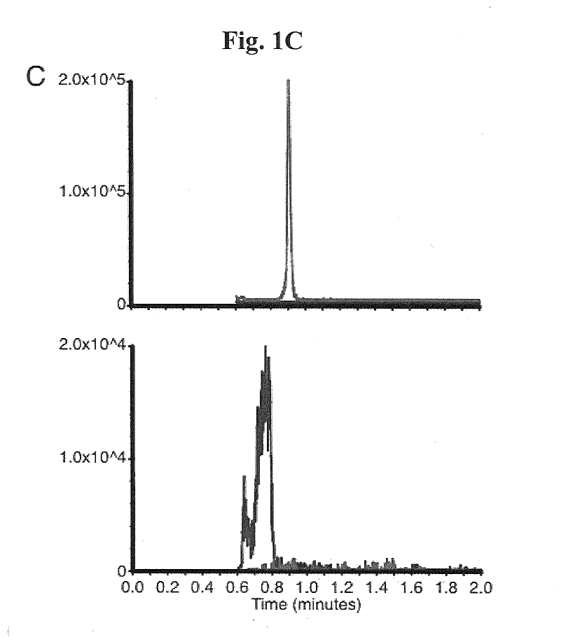

MRM parameters for detection of unhydrolyzed ertapenem have been described (Lefeuvre); a precursor/product ion pair of m/z 476.1→m/z 432.1 was used for monitoring of ertapenem (FIG. 1A, upper panel). For monitoring of hydrolyzed ertapenem, a precursor/product ion pair of m/z 494.1 →m/z 450.1 was used (FIG. 1A, lower panel). MS parameters for the detection of hydrolyzed ertapenem were tuned using spontaneously hydrolyzed ertapenem in H₂O, and the validity of this MRM scheme was confirmed using biologically hydrolyzed samples.

Ertapenem and its hydrolyzed form were detected by HPLC-MS/MS and it was further demonstrated that ertapenem was stable in TSB in the absence of carbapenemase producing bacteria after an overnight incubation. In the presence of KPC-producing bacteria, no unhydrolyzed ertapenem was detectable, and a new signal corresponding to hydrolyzed ertapenem was seen (FIG. 1B). An overnight incubation for the detection of carbapenemase activity did not provide an advantage over current testing modalities, but it was also shown that, using a standard bacterial inoculum, complete ertapenem hydrolysis was seen within 2 hours (FIG. 1C). Using this protocol, the limit of detection of the assay was approximately 1 ng/mL, and no ion suppression was observed at the ertapenem retention time. Thus, it was demonstrated that detection of bacterial carbapenemase activity can be performed, following the methods of the present invention, much more quickly than using existing phenotypic testing methods, and in fact is comparable to the timeframe of many genotypic tests. Thus, in one embodiment, the turn-around time (TAT) from colony isolation to result was equal to or less than approximately 2.5 hours, and hands-on time was approximately 15 minutes.

### Example 2

### Optimization for Clinical Detection of Bacterial Carbapenemase Activity by HPLC-MS/MS

Bacterial supernatants may contain non-precipitated polysaccharide capsule material and salts. Thus, a retention time for ertapenem and its hydrolyzed form of approximately 3 minutes is likely. This may allow for a solvent delay in order to prevent application of contaminating compounds on the MS instrument. The column can be washed for several minutes to maximize assay reproducibility. Experiments using a precolumn can be performed to assess its impact on the performance of the assay. Criteria that assess HPLC performance may include sensitivity, reproducibility, and peak resolution, for example. A total run time of under 8 minutes should be the goal in order to minimize TAT.

Further, changes in the HPLC conditions can affect the concentration and flow rate of the mobile phase entering the MS instrument. Thus, the MS method may be retuned using a mixture of ertapenem and its hydrolyzed form using these changed HPLC conditions to maximize assay sensitivity.

Ion suppression can also be assessed during performance of the optimized HPLC-MS/MS method by infusing a constant amount of a mixture of ertapenem and its hydrolyzed form, while injecting processed bacterial cultures through the HPLC.

The analytical characteristics of the assay can be defined by determining the accuracy, precision, limit of detection, and linearity of the assay. Repeated analysis of a characterized mixture of ertapenem and its hydrolyzed form can be used to assess the accuracy of the method. Precision can be determined by testing a characterized mixture of ertapenem and its hydrolyzed form daily for two weeks. The limit of detection and linearity of the assay for ertapenem can be determined using serial dilutions of a known concentration of ertapenem. Because hydrolyzed ertapenem is not commercially available, some parameters cannot be quantified at this time. Nonetheless, dilutions of hydrolyzed ertapenem can be assessed to determine the dynamic range of the assay for the detection of this form of ertapenem. A coefficient of variation (CV) of 20% can be achieved at approximately 1 mcg/mL of ertapenem.

Use of an internal standard is essential for monitoring assay performance. Internal standards are an accepted method of assessing for the presence of ion suppression. Changes in the peak intensity and/or retention time of the internal standard indicate problems with assay performance, and College of American Pathologist (CAP) guidelines for MS methods dictate the use of an internal standard. In certain embodiments, commercially available compounds can be used, but deuterated compounds are preferred as internal standards for MS assays because of their identical performance in sample preparation and HPLC but different molecular weight. In other embodiments, deuterated hydrolyzed ertapenem that is custom synthesized can be used. The internal standard can be added to the bacterial supernatant after incubation. Waters Intellistart software can be used to identify a suitable MS method for the detection of this compound. Suitability can be assessed based on similarity in retention time in HPLC, compatibility with MS/MS method, and similar extraction characteristics. In addition to ceftazidime, other compounds can be examined, beginning with other carbapenems and beta-lactam antibiotics, for example.

Hydrolysis patterns can be compared in 0.5 McF, 0.25 McF, and 0.05 McF cultures of KPC-positive bacteria at 0.5, 1, 2, and 4 hours using an optimized HPLC-MS/MS assay. KPC-negative bacteria with or without ESBL expression can be used for comparison. At standard bacterial inoculums of 0.5 McF, all the ertapenem can be hydrolyzed within about 2 hours. Because of the presence of bacterial cellular debris, the reproducibility of the assay under clinical conditions may be examined by monitoring the CV of repeated runs of the same samples. A minimum of 50 repeated runs can be achieved without the need for instrument maintenance (e.g. cleaning the cone). A CV of 20% in the peak intensities of the internal standard, ertapenem, and hydrolyzed ertapenem can be tolerated.

The methods and procedures of the present invention minimize the number of preparative steps required to three (for example, bacterial centrifugation, protein precipitation with ACN, and protein centrifugation) before HPLC-MS/MS analysis. In some embodiments, appropriate checklists from the College of American Pathologists can be used during assay optimization to facilitate a method validation process within a laboratory.

Additionally, the present invention includes a binary, qualitative interpretation of the presence or absence of carbapenemase activity, based on the complete hydrolysis of ertapenem as seen for the KPC-positive test strain. Non-KPC ESBLs exhibit some carbapenemase activity, and therefore rates of hydrolysis can differ from those for KPC-positive organisms. Thus, the present invention may further include interpretive guidelines considering these factors to reflect partial hydrolysis.

### Example 3

Determination of the Sensitivity, Specificity, and Speed of Mass Spectrometry to Detect Carbapenemase Activity Compared with Standard Laboratory Methods.

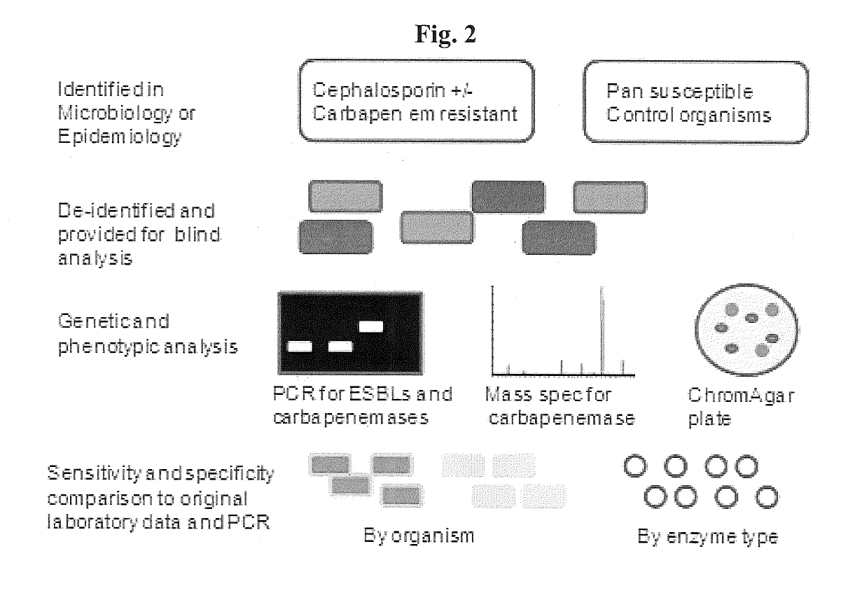

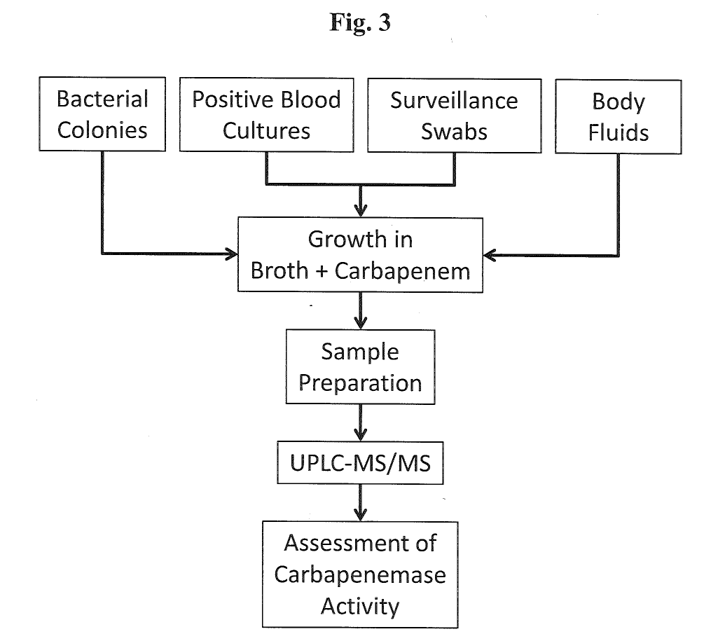

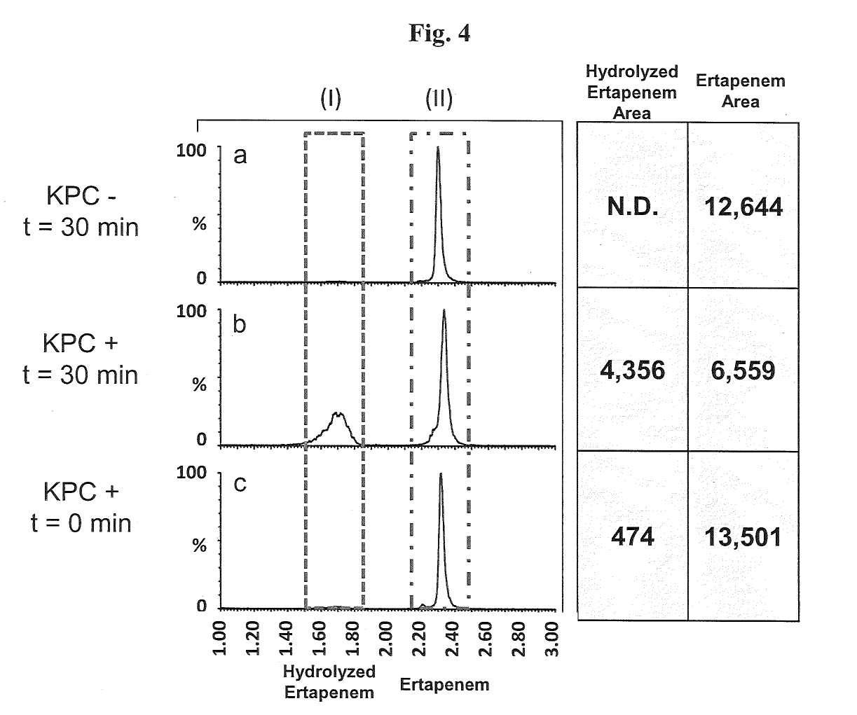

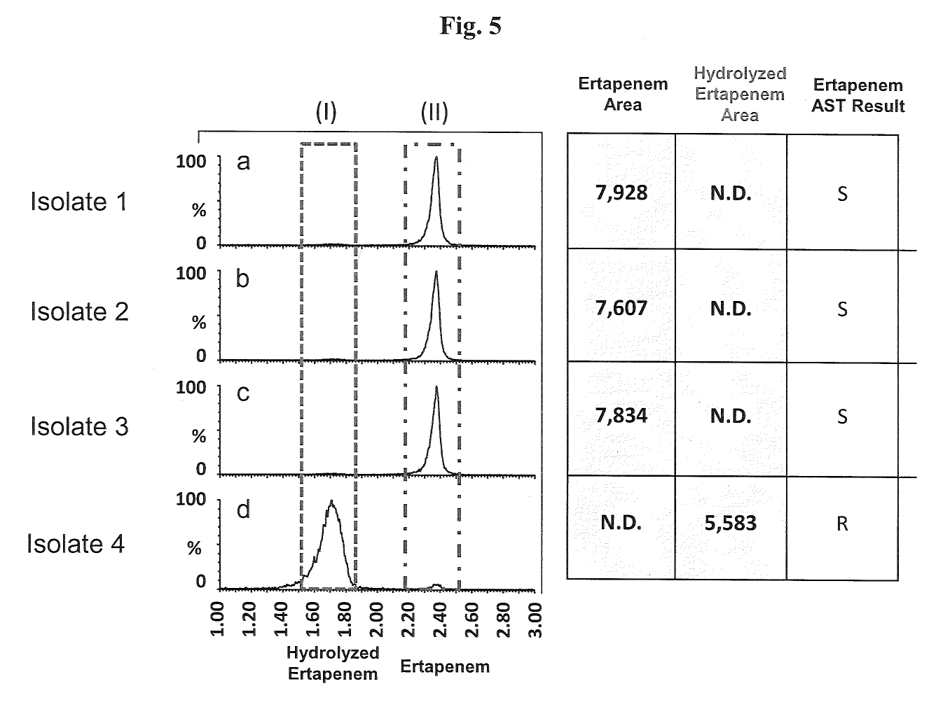

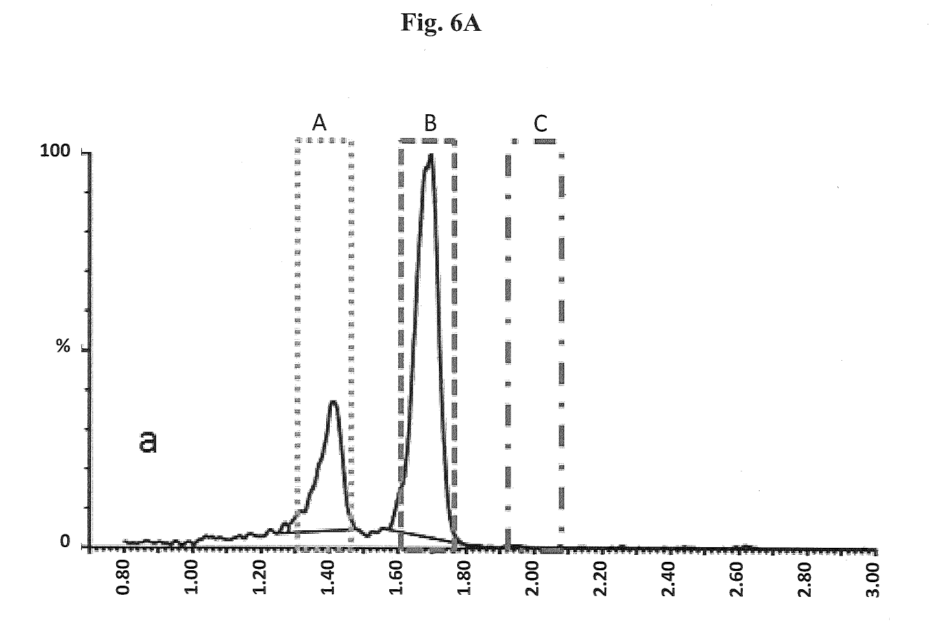

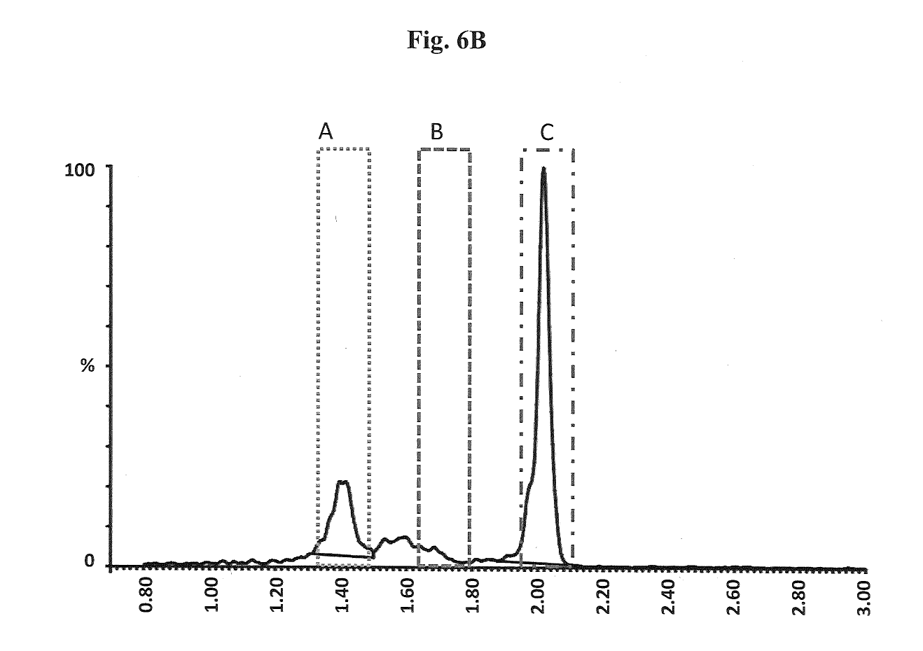

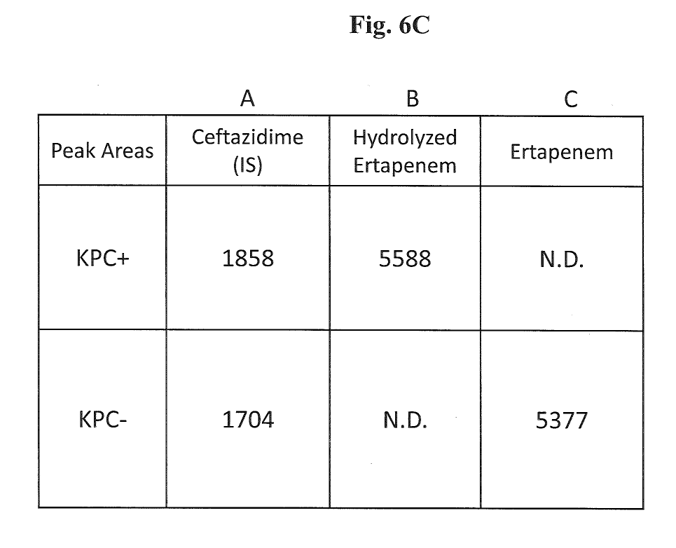

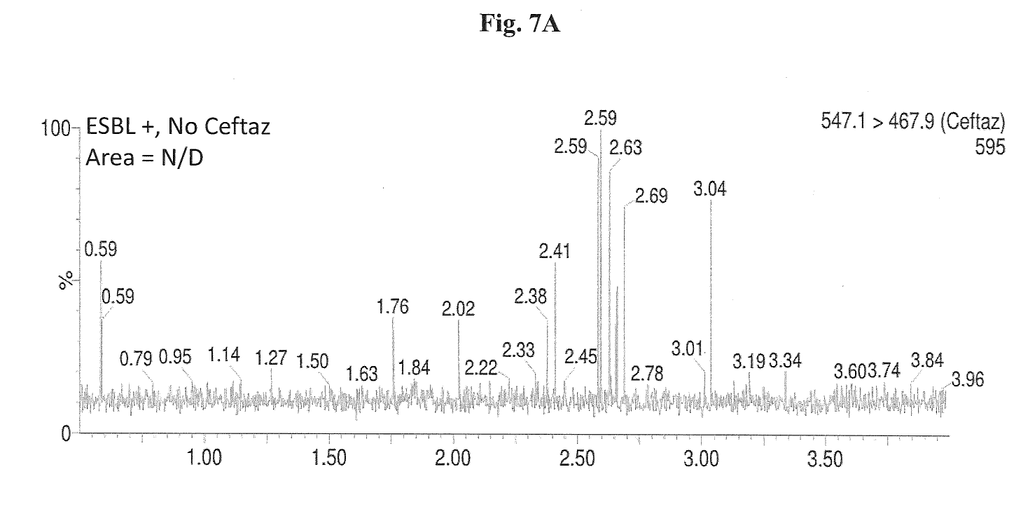

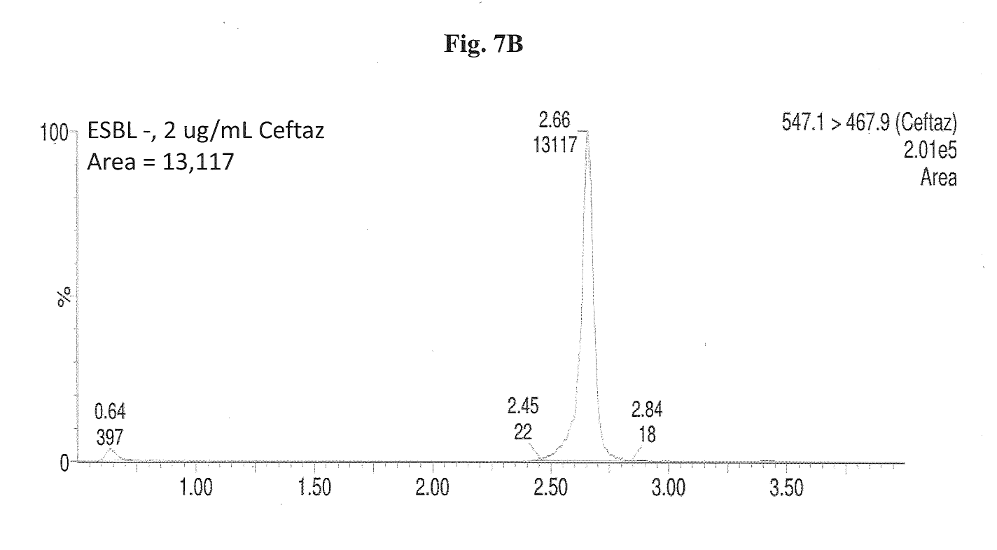

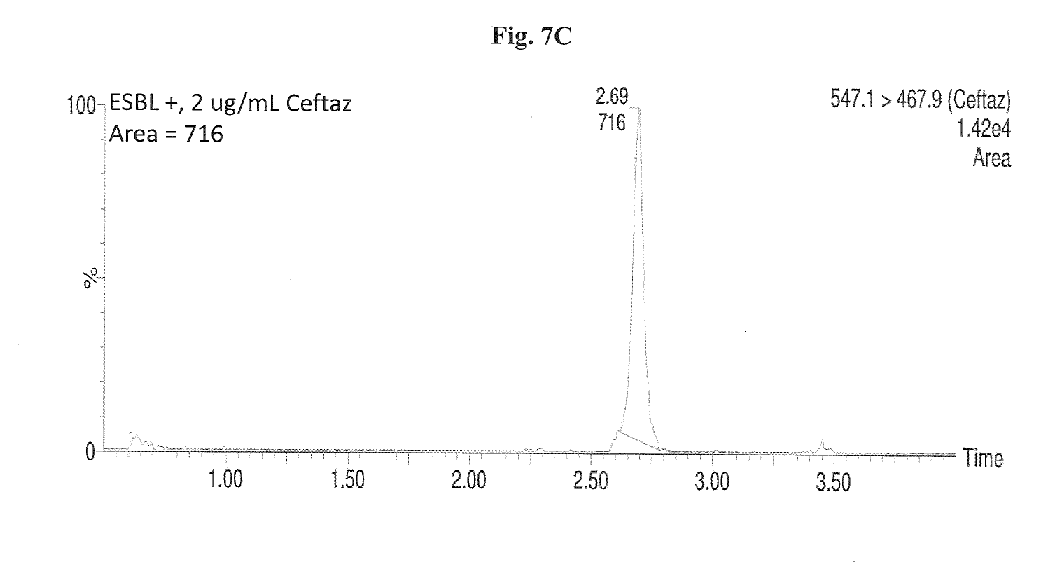

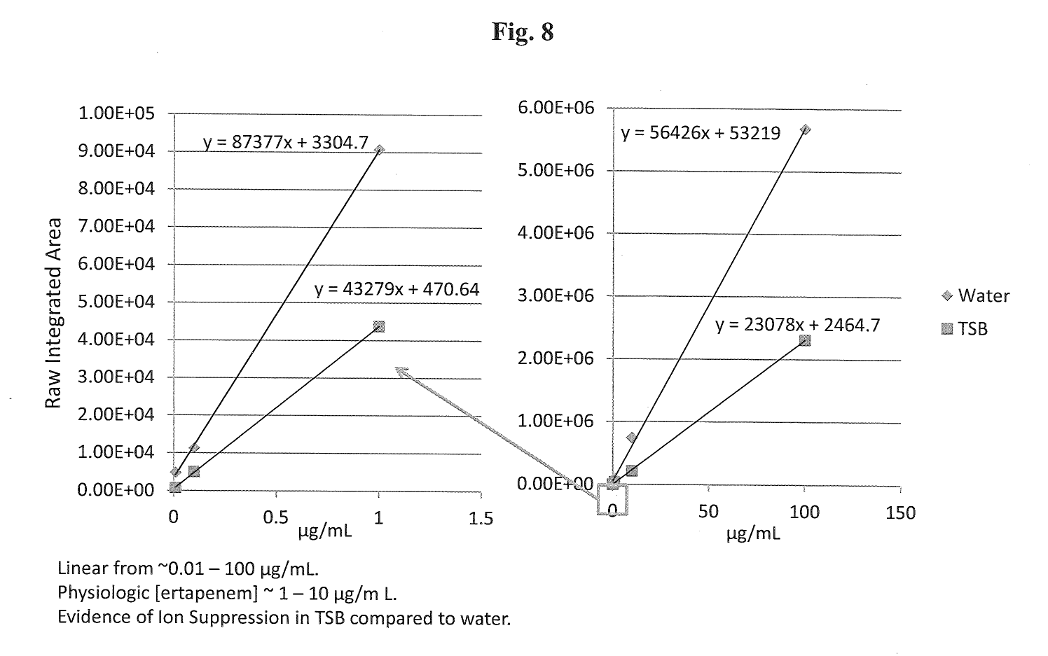

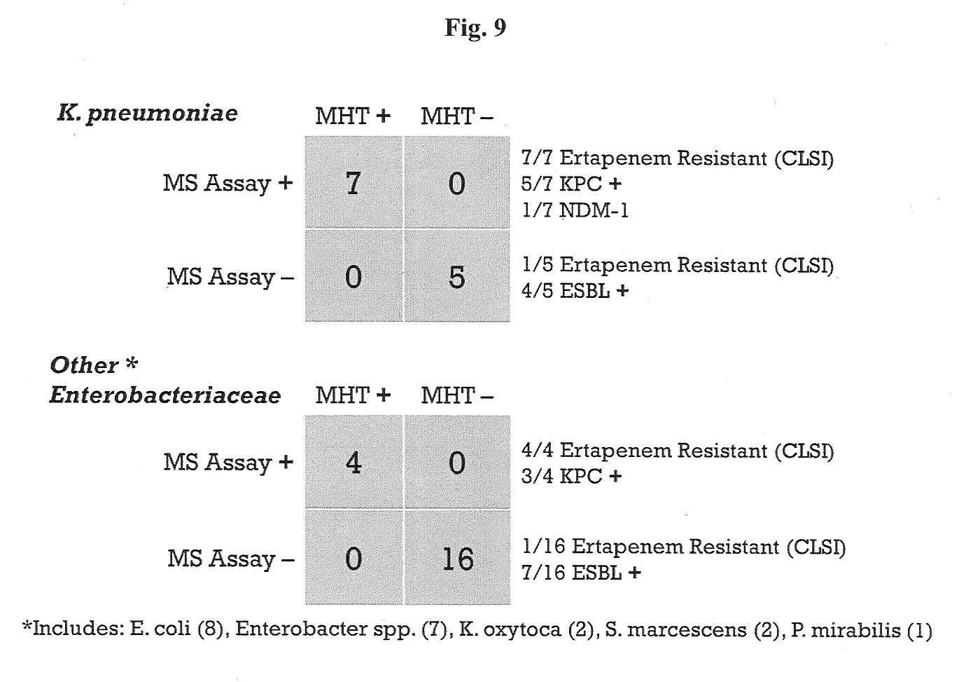

As illustrated in FIG. 2, mass spectrometry can be used as a diagnostic assay for carbapenem resistance, where the sensitivity and specificity of mass spectrometry can be analyzed. The clinical microbiology laboratory at Yale New Haven Hospital identifies approximately 10,000 Gram-negative organisms from blood, urine, wounds, respiratory specimens, and priority cultures such as spinal fluid per month (Table 1). Approximately 4% are resistant to carbapenems and 10 percent are resistant to 3^{rd} generation cephalosporins, such as ceftazidime. The most common carbapenem resistant organisms, as determined by automated microbroth dilution on the Vitek2 system, are the Klebsiella species and P. aeruginosa. Once a Gram-negative organism is isolated from pure culture, it is placed on the Vitek2 instrument for identification and susceptibility, with the results available the next day. This provides a turnaround time of 24 hours for a pure culture and up to 48 hours if the organism must be separated from other bacteria in the specimen. Recent changes in the CLSI guidelines to report ertipenem susceptibility now require an additional E-test to the testing protocol, adding an extra day.

TABLE 1
Microbiology at Yale New Haven Hospital over a 6 month period

| | | | Number for | % | Number for |
|---|---|---|---|---|---|
| Select | Number | % carbapenem | Prospective | ceftazidime | Prospective |
| Organisms | recovered | Resistant* | study | Resistant | study |
| E. coli | 1500 | 1% | 15 | 6% | 80 |
| P. aeruginosa | 600 | 5% | 30 | 6% | 36 |
| Klebsiella sp | 400 | 4% | 16 | 5% | 20 |
| Enterobacter sp | 120 | 18% | 22 | N/A | — |
| Total | 2660 | 3.1% | 83 | | 136 |

*includes meropenem and ertapenem, Cephalosporin resistance is not reported for enterobacter

Cephalosporin and carbapenem resistant organisms can be collected over a 6 month period from this clinical microbiology laboratory. Based on previous data, it is expected that this results in the collection of about 80 carbapenemase resistant organisms and 136 cephalosporn resistant organisms. An additional set of controls may be 5 susceptible organisms per resistant organism matched by species collected within the same week. These samples can be deidentified by the microbiology laboratory for blind testing of the resistance pattern when performing the mass spectrometry and chromagar plates.

While the specificity of the assay of the present invention can be rigorously tested, the sensitivity analysis may be limited by the small number of expected resistance organisms. To address this problem, a collection of all multi-drug resistant Gram-negative organisms assembled by the epidemiology laboratory for over a decade can be used. This will provide an additional one hundred carbapenemase resistant organisms deidentified and mixed with susceptible organisms provided by the microbiology laboratory. Phenotypic assays for secreted enzymes may include mass spectrometry, ESBL chromagar plates, and the results from tests performed in the clinical laboratory. PCR can be performed on all isolates to identify known ESBL's and carbapenemases. This will result in a pattern of susceptibility as determined by the clinical microbiology laboratory and as compared to the phenotypic and PCR results. Sensitivity and specificity analysis of mass spectrometry can then be compared with both PCR and the clinical microbiology results. Any isolates exhibiting hydrolysis of carbapenem, but which are PCR negative, can be further studied to determine the responsible enzyme. These studies will demonstrate how mass spectrometry compares with current techniques for the detection of carbapenemase activity, and establish the accuracy of the present invention across enzyme types, bacterial species, and body sites of infection more rapidly than existing techniques.

The present invention provides a single assay with uniform parameters that detects carbapenemase activity by multiple enzymes across different bacterial species. Because the performance of this assay can vary depending on either the species studied or the specific enzyme present (KPC vs metalloprotease), the optimal inoculum or time to detection can vary depending on the active enzyme. However, the present invention can still be performed with one set of conditions that works for all assays, or with customized conditions for particular species and/or enzymes.

### Example 4

### Illustrative Analysis Protocol

Specimen: Isolated bacterial colony.

Materials: Ertapenem, Tryptic Soy Broth (TSB), acetonitrile, water, formic acid

Equipment: 37° C. incubator or water bath, microcentrifuge, UPLC-MS/MS instrument

### Sample Preparation:

TSB is prepared by adding ertapenem to a final concentration of 2.5 μg/mL. Using a sterile swab, a 0.5 McFarland (McF) suspension of well isolated colonies in TSB +ertapenem is prepared. The system is incubated at 37° C. for the indicated period of time.

1 mL of bacterial suspension is removed and transferred to 1.5 mL microcentrifuge tube. The system is centrifuged at 13,000 RPM for 5 minutes at room temperature. 500 μL of supernatant are removed, and placed in a new microcentrifuge tube. 500 μL, of 100% acetonitrile are added. The system is vortexed for approximately 30 seconds and centrifuged at 13,000 rpm for 5 minutes at room temperature. 500 μL of supernatant is removed to new microcentrifuge tube or glass vial suitable for liquid handling unit of UPLC.

### UPLC Conditions:

### Column:

2.1×100 mm Waters column,
HSS (high strength silica), T3 (tri-alkyl) C18,
1.8 μm particle size, 100 Å pore size

### Mobile Phase:

A: water+0.1% formic acid
B: acetonitrile+0.1% formic acid

### Program:

Inject 25 μL at 0.0 min
0.0-0.5 min: 10% B (90% A), divert to waste
0.5-4.0 min: linear gradient from 10-20% B
4.0-6 0 min: column wash with 20% B
6.0-7.0 min: column re-equilibration at 10% B

TABLE 2
MS Conditions

| | | | | Collision |
|---|---|---|---|---|
| Compound | MRM | Dwell (ms) | Cone Voltage | Energy |
| Ertapenem | 476 → 432 | 30 | 22 | 12 |
| Hydrolyzed | 494 → 450 | 30 | 22 | 12 |
| Ertapenem | | | | |

### Example 5

### Extended Spectrum Beta Lactamase Assay

The sample (bacteria, centrifuged material, or direct patient specimens) is inoculated into growth broth containing an antibiotic or antibiotics (such as ceftazidime and/or cefotaxime, but may include ceftriaxone or another beta lactam). The broth solution may contain additional compounds (e.g. pH indicators, internal standards, etc). A paired sample with antibiotic+beta lactamase inhibitor (e.g. cefotaxime+clavulinic acid) may be required for complete interpretation of ESBL activity.

The sample is incubated for a specified period of time at a specified temperature. The supernatant is processed and subjected to mass spec analysis. All mass spec targets consist of specific precursor/product ion pairs. Specific mass spec targets may take several forms, such as but not limited to:
reduction in the intensity of the parent/unmodified drug that is blocked in a parallel sample by the presence of a beta lactamase inhibitor
reduction in the intensity of the parent/unmodified drug and the appearance of the hydrolyzed form of the parent drug
reduction in the intensity of the parent/unmodified drug and the appearance of an ion(s) that is/are specifically derived from the covalent modification of the parent drug (e.g. a decarboxylated, and/or hydrolyzed ion)

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

1. A method of detecting the presence of antibiotic resistant bacteria in a sample, comprising:
analyzing a sample via mass spectrometry to produce a data set; and
determining from the data set the presence or absence of a covalently modified antibiotic compound in the sample,
wherein the presence of the covalently modified antibiotic compound in the sample is indicative that the sample comprises bacteria that are resistant to the antibiotic,
and wherein analyzing the sample via mass spectrometry comprises analyzing the sample using a LC-MS/MS system.

2. The method of claim 1, wherein the presence in the sample of the covalently modified antibiotic compound is further indicative of the presence in the sample of an active enzyme capable of covalently modifying the antibiotic.

3. The method of claim 2, wherein the active enzyme comprises a hydrolase.

4. The method of claim 3, wherein the hydrolase comprises a beta-lactamase.

5. The method of claim 4, wherein the beta-lactamase comprises a carbapenemase.

6. The method of claim 5, wherein the antibiotic compound comprises a carbapenem.

7. The method of claim 1, wherein determining the presence or absence of a covalently modified antibiotic compound comprises comparing the data set to spectral analysis standards of the antibiotic compound in both a covalently modified and unmodified state.

8. (canceled)

9. The method of claim 1, wherein the LC-MS/MS system comprises UPLC-MS/MS.

10. The method of claim 1, wherein the sample is from a patient.

11. The method of claim 10, wherein the sample is derived from a source comprising blood, a blood culture, an epidemiologic surveillance swab, a body fluid, and combinations thereof.

12. The method of claim 1, wherein the sample is not from a patient.

13. The method of claim 1, wherein determination of the presence or absence of antibiotic resistant bacteria is made in less than about 2 hours.

14. The method of claim 1, wherein at least the determination of the presence or absence of antibiotic resistant bacteria is automated.

15. A method of detecting hydrolytic enzyme activity of drug resistant bacteria in a sample, comprising:
obtaining standards for the spectral analysis of at least one antibiotic compound in both a hydrolyzed and unhydrolyzed state;
analyzing a sample via mass spectrometry to produce a data set;
comparing the data set to the standards; and
determining the presence or absence of a hydrolyzed antibiotic compound in the sample,
wherein the presence of the hydrolyzed antibiotic compound in the sample is indicative of the presence of an active hydrolytic enzyme that promotes bacterial resistance to the at least one antibiotic compound, and
wherein analyzing he sample via mass spectrometry comprises analyzing the sample using a LC-MS/MS system.

16. The method of claim 15, wherein the hydrolytic enzyme comprises a beta-lactamase.

17. The method of claim 16, wherein the beta-lactamase comprises a carbapenemase.

18. The method of claim 17, wherein the at least one antibiotic compound comprises a carbapenem.

19. (canceled)

20. The method of claim 15, wherein the LC-MS/MS system comprises UPLC-MS/MS.

21. A kit for determining the presence or absence of drug resistant bacteria in a sample, comprising:
reagents for preparing and performing a spectral analysis of a sample; and
instructions for the set-up, performance, monitoring, and interpretation of the assay to determine the presence or absence of a covalently modified antibiotic compound in the sample,
wherein the spectral analysis comprises using a LC-MS/MS system;
wherein the presence of a covalently modified antibiotic compound in the sample is indicative of the presence of an active enzyme that promotes bacterial resistance to the antibiotic compound.

22. The method of claim 21, wherein the LC-MS/MS system comprises UPLC-MS/MS.
